(19) United States
(12) Patent Application Publication
(10) Pub. No.: US 2019/0366497 A1
(43) Pub. Date: Dec. 5, 2019

(54) MACHINING DEVICE AND METHOD FOR ASSEMBLING THE MACHINING DEVICE

(71) Applicant: HOMAG GmbH, Schopfloch (DE)

(72) Inventors: Marcel STEEB, Baiersbronn-Mitteltal (DE); Peter DETTLING, Horb (DE); Michael THUMM, Neustetten (DE); Jochen BECK, Horb (DE)

(21) Appl. No.: 16/425,712

(22) Filed: May 29, 2019

(30) Foreign Application Priority Data
Jun. 1, 2018 (DE) 10 2018 208 678.8

(51) Int. Cl. B23Q 7/03

(52) U.S. Cl. CPC B23Q 7/035

(57) ABSTRACT

The invention relates to a machining device for machining a workpiece with a continuous guide rail for a conveying device, in particular a chain conveyor, as well as a first module and a second module which are connected to one another by means of the continuous guide rail, in order to form a base body.

The present invention relates to a machining device which, for example, is used for machining plate-shaped workpieces, as well as a method for assembling a machining device.

In particular, the aforementioned machining device is a throughfeed machine which has one or more conveying devices for moving a workpiece. For example, such a machining device is used in the field of the furniture and component industry in order to machine workpieces of wood, wood materials, composite materials or similar.

### PRIOR ART

With a throughfeed machine, workpieces moving in a throughfeed direction are machined. For example, within the scope of such a machining, edges can be milled, coating material can be applied/glued to narrow sides, and a post-processing can be carried out. Furthermore, grooves, for example, can be introduced to such a workpiece.

Conventionally, such a throughfeed machine has an inlet area, an aggregate area and an outlet area. In known machines, the machine stand and the top pressure device used for holding down the workpiece are each manufactured from one piece.

In many cases, a throughfeed machine has dimensions such that it has to be divided into partial sections for the subsequent transport. These sections are joined together at the assembly site to form a complete machine.

According to DE 199 20 950 A1, an edge machining device is known. The edge machining takes place in throughfeed between an inlet station and an outlet station with transport chains extending between them and guided on tracks, which run along various machining stations.

The machining stations thereby consist of one segment and at least one module, with the segment having track sections for the transport chains and a base support, and the module comprising the machining aggregates, if necessary the soundproof hood, the power supply and control components including the switch cabinet and pneumatic connection.

Furthermore, EP 1 033 201 A2 is known which shows an edge machining device for strip-shaped and plate-shaped workpieces. The machine stand of this machine is composed of at least two modules disposed one behind the other in the direction of conveyance of the chain transporters, with each module enclosing an internal space for receiving the processing devices and having end faces of mirror-inverted design with flange faces and flange bores and also a centering groove for accommodating a centering strip for attachment to, or alignment with an adjoining module, an integrated linear receptacle, associated with the chain transporter, for a chain guide strip, and also connections for a driving chainwheel mounting arrangement and a tensioning chainwheel mounting arrangement.

Further to be mentioned is DE 44 16 922 A1, which shows a machine for machining, with the machine having a frame stand in the form of a shell body construction, which is formed as a self-supporting truss as well as a supporting machine frame, and completely enclosing a machining cell or a work space, as well as further accommodating machine beds or machine stands, guide and transport systems, machining stations and the like, and for this has fixing surfaces and line bores.

However, the machining devices described in the prior art have the disadvantage that all segments must be manufactured with a high accuracy to one another and the sections must be very precisely aligned to one another. Consequently, the manufacturing tolerances must be kept relatively low and the assembly must be carried out precisely on-site. This in turn increases the cost of such a machining device.

### SUBJECT MATTER OF THE INVENTION

An object of the present invention is to efficiently design the structure of a machining device and thereby increase the flexibility.

The subject matter of claim 1 provides such a machining device. Further preferred embodiments are specified in the dependent claims. Furthermore, the invention relates to a method.

The invention has the advantage that a customer-specific machining device can be created through the combination of pre-defined modules. Consequently, a commission-independent manufacturing can be ensured and thereby the manufacturing costs are reduced by the modules. Overall, there is an increase in efficiency in the processing of orders for the creation of customer-specific machining devices. The provided interfaces make it possible to use machining aggregates across a series of products. Furthermore, a fast exchangeability of components in the event of maintenance is guaranteed.

According to the invention, a machining device for machining a workpiece is provided which has: a conveying device for moving a workpiece, said conveying device having a continuous guide rail. The conveying device can be formed as a chain conveyor. Furthermore, the machining device comprises a first module and a second module which are connected to one another by means of the guide rail, in order to form a base body. Consequently, the guide rail constitutes a central element in the modular concept. The guide rail can provide a cost-effective and conceptually comparatively simple interface. Extension modules can be freely defined by a customer so that customer-specific constructions are made possible Furthermore, it is possible to prefabricate each of the individual modules.

According to the claim, a continuous guide rail is provided, with it being preferred that the continuous guide rail in the assembled state of the machining device extends in a horizontal direction. This means that the guide rail bridges the interface between the aforementioned modules. In particular, the guide rail is supposed to be arranged in such a manner that the guide rail extends along the modules of the machining device, without the guide rail itself having an interface in the connecting area between the modules.

According to a preferred embodiment, it is provided that the guide rail extends along the first and second module and further preferably protrudes at one or both outer end sections of the modules.

The number of modules is not limited, and therefore the machining device can have two modules, three modules, four modules, or further modules. The modules can be formed differently or similarly. According to an embodiment, it is preferred that the machining device has two or more similar modules.

If the machining device has three or more modules, the guide rail can therefore be formed in two parts as well. However, in this case it is provided that a part of the guide rail extends along at least two modules of the machining device and the connection between the parts of the guide rail are provided at a distance from the connection area between the modules.

To connect the modules with the guide rail, for example, a connection mechanism is provided which can already be contained in the machine stand of each module itself (for example, feather key connection, clamp connection, screw connection, feather key, etc.).

The minimal irregularities of the interconnected modules can be compensated for by the continuous guide rail, so that high-precision and continuous workpiece transport can be ensured.

Furthermore, according to an embodiment, the modules can be connected to one another in a frictional connection manner, in particular by means of at least one clamping connection. Consequently, in addition to the central connection by means of the guide rail, a connection between the modules is provided.

According to an embodiment, at least one of the modules has a pre-assembled machining aggregate, for example a milling aggregate. The pre-assembled machining aggregate can be prepared in a corresponding module in accordance with a customer's request. Consequently, the efficiency during the assembly is increased.

Furthermore, it can be provided that the modules accommodate a top pressure device which extends at least in sections adjoining to the conveying device. The top pressure device can be provided as a further connecting element, with the guide rail enabling a relative alignment of the modules.

According to an embodiment, it is provided that the guide rail is a chain guide rail.

In an embodiment, it is provided that the guide rail is formed with a raster or raster-like elements. Consequently, the guide rail can be provided in any length and prepared for the specific machining device. The modules are connected with the guide rail corresponding to the raster or the raster-like elements. Consequently, interfaces of the base machine and extension modules do not have be customer-specifically distinct, but rather these interfaces are provided globally. Attachment parts that are supposed to be or must be moved when inserting a special module can be moved flexibly.

It is preferred that the modules in the extension direction of the guide rail are essentially dimensioned equally. Consequently, the overall dimensioning of the machining device can be simplified.

Furthermore, it can be provided that the modules have assembly locations for machining aggregates, with the number, and preferably the position, of the assembly locations for machining aggregates being equal.

Alternatively or additionally, it is provided that the assembly locations are arranged in such a manner that the assembly locations are equally spaced to the guide rail. In other words, the assembly locations have the same reference to the guide rail.

Furthermore, it can be provided that the machining device has three or more modules. The continuous guide rail thereby connects the modules to a machining device.

Furthermore, a method for assembling a machining device is provided, with the machining apparatus being configured to machine a workpiece. The method comprises the steps: Providing a conveying device, said conveying device having a guide rail, and connecting a first module and a second module by means of the guide rail in order to form a base body of the machining device.

It is provided in an embodiment that a top pressure device is assembled on the base body, with the top pressure device extending at least in sections parallel to the conveying device. Consequently, the base body is formed through the connection between guide rails and the modules, and the top pressure device is assembled on this base body.

Is it preferred that before connecting the first and second modules, electrical and/or pneumatic lines or connections are pre-installed in each module. Consequently, the modules are prepared for later assembly.

It can be provided that after connecting the first and second module, the modules are electrically and/or pneumatically connected to one another. The corresponding lines can, for example, be guided along the guide rail, or alternatively directly from module to module.

According to an embodiment, it is preferred that before connecting the modules with the guide rail to a base body, in at least one of the modules a machining aggregate is installed. Consequently, the module is already inserted into the machining device in an operational state.

According to a further embodiment, it is provided that the modules are tested individually before connection. Consequently, the functionality of the modules can be checked within the scope of a pre-commissioning. In this manner, possible error sources can be more quickly identified and correspondingly eliminated more rapidly. Furthermore, the time frame for final assembly can be shortened.

Features of individual method claims and/or previously mentioned aspects can be used with the machining device. Features of individual device claims and/or previously mentioned aspects can be used in the method.

### BRIEF DESCRIPTION OF THE DRAWINGS

FIG. 1 shows a schematic side view of a machining device according to a first embodiment of the present invention.

FIG. 2 shows a module of the machining device shown in FIG. 1, viewed in a lateral direction.

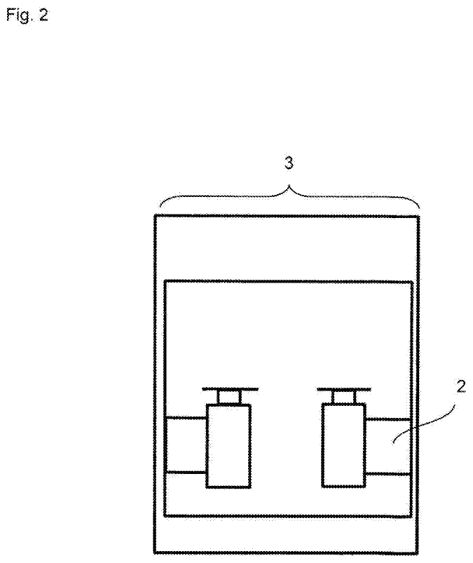

FIG. 3 is a top view of a basic structure of the module shown in FIG. 2.

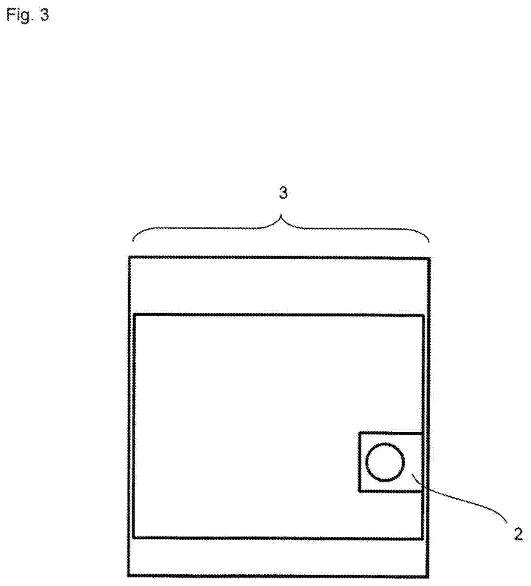

FIG. 4 shows a second embodiment of the invention

### DETAILED DESCRIPTION OF A PREFERRED EMBODIMENT

Preferred embodiments of the present invention are described below by means of the accompanying figures. Modifications of certain individual features can each be combined with one another individually in order to form new embodiments. The described embodiment example is thereby not to be considered restrictive, but rather this primarily serves the descriptive explanation of the present invention.

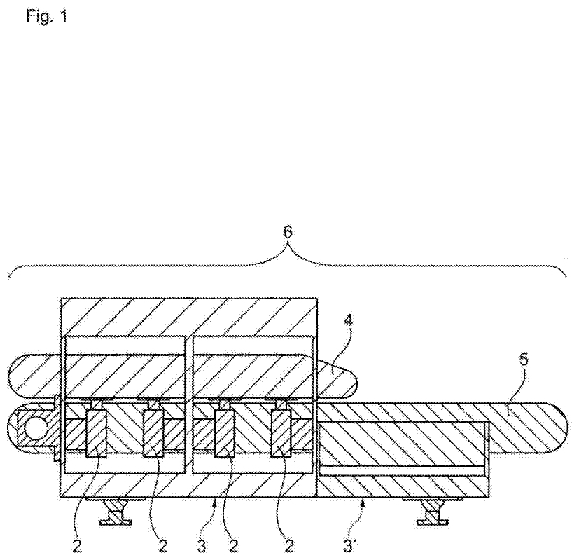

FIG. 1 shows a machining device 6 in a side view, with the machining device 6 being formed as a throughfeed device. The machining device shown in FIG. 1 was composed of the elements that are described below.

The machining device 6 comprises a first module 3 and a second module 3′, with the modules 3, 3′ being connected to one another at an interface. In this regard, a continuous chain guide rail 5 of a conveying device is provided. Furthermore, a top pressure device 4 is provided.

During the assembly of the machining device 6 the modules are aligned, joined together and subsequently joined together or finally assembled into a machine with the continuous chain guide rail 5 of the conveying device and the top pressure device 4.

The top pressure device 4 extends at least in sections parallel to the chain guide rail 5 of the conveying device. The top pressure device 4 and the chain guide rail 5 of the conveying device are arranged in such a manner that a workpiece can be clamped between them in throughfeed, so that by means of machining aggregates 2 machining processes can be carried out on the workpieces moved in throughfeed.

Each module 3, 3′ comprises a body which, for example, was made of a metallic casting material or a concrete material. Alternatively, it is possible to compose the body of the modules from different elements which are welded, screwed or glued to one another.

In the present embodiment example, the first module 3 comprises a floor, vertical struts, and an upper part. Furthermore, the first module 3 is equipped with a foundation strut.

The second module 3′ is formed by a base and a support. The second module 3′ also comprises a foundation strut.

When the modules 3, 3′ are connected to one another by means of the chain guide rail of the conveying device 5, a foundation strut can therefore be arranged in the area of its interface.

The machining aggregates 2 can be, for example, milling tools which carry out machining processes on a narrow side of a plate-shaped workpiece. The machining aggregates 2 are attached to the prepared interfaces of the module 3.

A method for assembling a machining device can be carried out as follows.

Firstly, the modules 3, 3′ are manufactured and prepared. If, for example, it is a first module 3 of a casting material, the body of the module 3 is formed in a casting method. Subsequently, pneumatic and electrical lines and connections are provided and pre-assembled in the first module 3. The same occurs with further modules. The modules prepared in this manner can be stored and used to build a machining device in the event of a specific order.

Depending on a customer's request, machining aggregates 2 are then pre-assembled on the module (here module 3) in a further method step. In the present embodiment example, the first module 3 comprises eight machining aggregates, with only four of these machining aggregates 2 being shown in the side view of FIG. 1.

The first module 3 and the second module 3′ are subsequently brought to the installation site together with the conveying device 5 formed according to a customer's request, and the correspondingly manufactured top pressure device 4. There, the modules 3, 3′ are firstly aligned, joined together and subsequently connected by means of the chain guide rail and wedded to a machine by means of the top pressure. The modules 3, 3′ are additionally connected to one another, for example, by means of a clamping connection or a frictional connection.

At the installation site, electrical and/or pneumatic lines and connections of the modules 3, 3′ are connected to one another. Furthermore, the chain conveyor of the conveying device is assembled on the chain guide rail. Accordingly, the top pressure device 4 in the present embodiment example is assembled on the first module 3 in such a manner that a conveyor gap is formed between the conveying device 5 and the top pressure device 4.

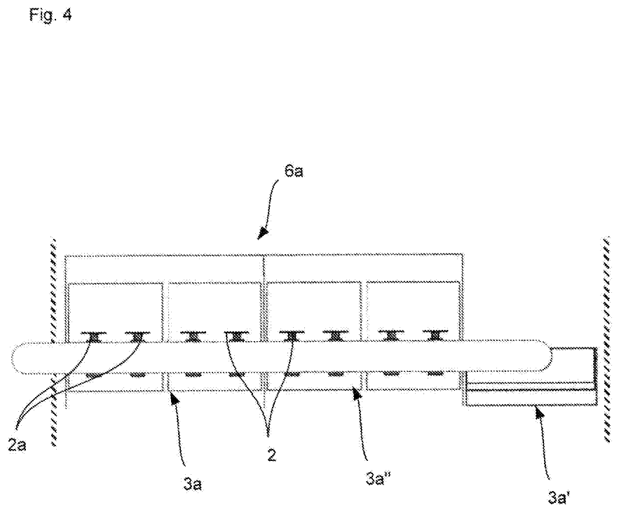

In FIG. 4, a second embodiment of the invention is shown. The machining device 6a according to the second embodiment comprises a first module 3a, a second module 3a′ as well as a third module 3a″, with the third module 3a″ being inserted between the first module 3a and the second module 3a′.

Similarly to the first embodiment, the machining device 6a comprises a conveying device with a guide rail 5a. The guide rail 5a is provided continuously and consequently extends along the first module 3a, the third module 3a″ as well as in sections of the second module 3a′. Consequently, the modules can be aligned and connected to one another during the assembly of the machining device 6a by means of the guide rail 5a.

The first module 3a and the third module 3a″ each comprise several machining aggregates 2a. The position of the machining aggregates 2a is thereby similarly formed at the first module 3a and the third module 3a″. However the machining aggregates themselves differ, so that by means of the machining aggregates 2a different machining steps can be carried out on a workpiece moved in throughfeed.

What is claimed is:

1. A machining device for machining a workpiece, comprising:
a continuous guide rail for a conveying device; and
a first module and a second module that are connected to one another by the continuous guide rail, in order to form a base body.

2. The machining device according to claim 1, wherein machining the workpiece corresponds to machining a plate-shaped workpiece in throughfeed.

3. The machining device according to claim 1, wherein the conveying device is a chain conveyor.

4. The machining device according to claim 1, wherein the modules are furthermore connected to one another in a frictional connection manner.

5. The machining device according to claim 4, wherein the frictional connection manner comprises at least one screw connection or clamping connection.

6. The machining device according to claim 1, wherein at least one of the modules has a pre-assembled machining aggregate.

7. The machining device according to claim 6, wherein the pre-assembled machining aggregate is a milling aggregate.

8. The machining device according to claim 1, wherein the modules accommodate a top pressure device which extends at least in sections adjoining to the guide rail.

9. The machining device according to claim 1, wherein the guide rail is a chain guide rail.

10. The machining device according to claim 1, wherein the guide rail is formed with a raster or raster-like elements.

11. The machining device according to claim 1, wherein the modules in the extension direction of the guide rail are essentially dimensioned equally.

12. The machining device according to claim 1, wherein the modules have assembly locations for machining aggregates,
wherein
the number of the assembly locations for machining aggregates is equal, and/or
the assembly location is arranged in such a manner that the assembly locations are equally spaced to the guide rail.

13. The method according to claim 12, wherein the position of the assembly locations for machining aggregates is equal.

14. The machining device according to claim 1, wherein the machining device has 3 or more modules.

15. A method for assembling a machining device for machining a workpiece, comprising the steps:
providing a continuous guide rail of a conveying device; and
connecting a first module and a second module by the guide rail, in order to form a base body of the machining device.

16. The method according to claim 15, wherein the conveying device is a chain conveyor.

17. The method according to claim 15, wherein before or after the assembly of the guide rail, a top pressure device is assembled on the base body, the top pressure device extending at least in sections parallel to the guide rail.

18. The method according to claim 15, wherein before connecting the first and second modules, electrical and/or pneumatic lines or connections are pre-installed in each module.

19. The method according to claim 15, wherein after connecting the first and second modules, the modules are electrically and/or pneumatically connected to one another.

20. The method according to claim 15, wherein before connecting the modules to a base body, a machining aggregate is installed in at least one of the modules.

21. The method according to claim 15, wherein the modules are individually tested before connection.
